(19) United States
(12) Patent Application Publication
(10) Pub. No.: US 2018/0146009 A1
(43) Pub. Date: May 24, 2018

(54) COMPUTER NETWORK SECURITY SYSTEM FOR PROTECTING AGAINST MALICIOUS SOFTWARE

(71) Applicant: Brad Austin Primm, Lewis Center, OH (US)

(72) Inventor: Brad Austin Primm, Lewis Center, OH (US)

(21) Appl. No.: 15/817,971

(22) Filed: Nov. 20, 2017

Related U.S. Application Data
(60) Provisional application No. 62/424,039, filed on Nov. 18, 2016.

(51) Int. Cl. H04L 29/06; G06F 21/56

(52) U.S. Cl. CPC H04L 63/1491; G06F 2221/034; G06F 21/565

(57) ABSTRACT

A computer network security system is provided. The system offers a last line of defense against malicious software through a novel software adapted to detect and deploy defensive action against the presence of malicious activity in a shared file environment. The novel software allows the administrator to create random honeypot files of known parameters that can be stored in vulnerable folders in a user-friendly manner. The novel software constantly monitors those files. If the novel software detects any unwanted action on the monitored honeypot files, through detection of a change in the known parameters, the present invention deploys defensive actions to protect the server including establishing fire walls and cessation of file sharing. Once defensive actions have been taken, the software reports all active sessions and open files as of the time of detection.

### CROSS-REFERENCE TO RELATED APPLICATION

This application claims the benefit of priority of U.S. provisional application No. 62/424,039, filed 18 Nov. 2016, the contents of which are herein incorporated by reference.

### BACKGROUND OF THE INVENTION

The present invention relates to computer networking systems and, more particularly, a computer network security system embodying a novel software for protecting against malicious software.

Sharing files in a computer network is a virtual necessity in most businesses. However, a problem unique to computer networks and said shared files is vulnerability to malicious software. Malicious software can be used to disrupt computer operation, gather sensitive information, and/or gain access to private computer systems. It can appear in the form of code, scripts, active content, and other software, and includes computer viruses, ransomware, worms, spyware, adware, and the like.

Intrusive file modification and encryption from rouge clients and malicious software can result in the paying of ransoms to the thieves that created the malicious software commonly referred to as ransomware. Small and mid-sized businesses are especially vulnerable to such attacks because they have neither the resources or professional IT staff needed to create customized defenses against ransomware attacks. Paying the ransom puts the victim at the mercy of thieves. Restoring from a backup loses recently entered data and can take up a lot of valuable time, depending upon the data size of the backup files. In addition, if the ransom is paid there is often a long wait time just to receive the encryption key, especially if the ransomware was sent by an overseas attacker, and the encryption key may not work. Furthermore, backups frequently fail.

Traditional antivirus programs rely on detecting malicious software before it is launched. If the malicious software is not recognized as a threat, however, then the network is at risk.

As can be seen, there is a need for a computer network security system for protecting against malicious software through a novel software adapted to set up protections for multiple computers in a shared file environment. Since this novel software stops the unwanted file modifications after the malicious software has been launched, it becomes a very effective “last line of defense” against this type of attack. The novel software prevents unwanted encryption and alerts the victim's computer administrator that an attack has occurred so that the administrator then removes the ransomware and restarts network services.

### SUMMARY OF THE INVENTION

In one aspect of the present invention, a method for identifying a presence of malicious software within a computer network includes storing a nonfunctional file having at least one original characteristic in a computer readable storage device, wherein the nonfunctional file has no use outside of identifying the presence of malicious software; and monitoring the nonfunctional file for determining a change in any original characteristic.

In another aspect of the present invention, a method for identifying a presence of malicious software within a computer network includes storing by way of a graphical user interface or a text file with parameters a nonfunctional file having at least one original characteristic in a computer readable storage device that requires protection, wherein the nonfunctional file has no use outside of identifying the presence of malicious software, and wherein the at least one original characteristic includes one or more of the following: a file size, location, presence and type; naming the nonfunctional file a predetermined name whereby users of the computer network know to not use said nonfunctional file; monitoring the nonfunctional file for determining a change in any original characteristic, wherein each original characteristic is transmitted to a server application that provides the monitoring; blocking commands within the computer network if a change in any original characteristic is determined, wherein a speed of the blocking commands is such that malicious software is blocked before damage to functional files can occur; and reporting all active sessions and open files within the computer network upon said determination, whereby a user may locate, isolate, and remove the malicious software from the computer network.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention illustrating deployment; and

FIG. 2 is a flowchart of an exemplary embodiment of the present invention in action.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a computer network security system for protecting against malicious software through a novel software adapted to detect and deploy defensive action against the presence of malicious activity in a shared file environment. The novel software allows the administrator to create random honeypot, nonfunctional files of known parameters that can be stored in vulnerable folders in a user-friendly manner. The novel software constantly monitors those files. If the novel software detects any unwanted action on the monitored honeypot files, through detection of a change in the known parameters, the present invention deploys defensive actions to protect the server including establishing fire walls and cessation of file sharing. Once defensive actions have been taken, the software reports all active sessions and open files as of the time of detection.

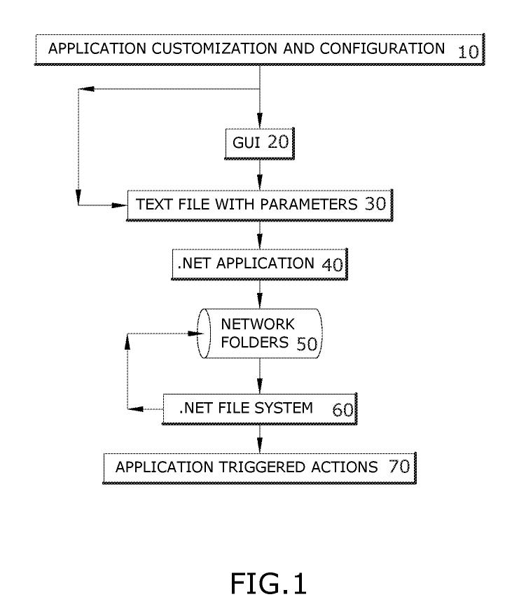

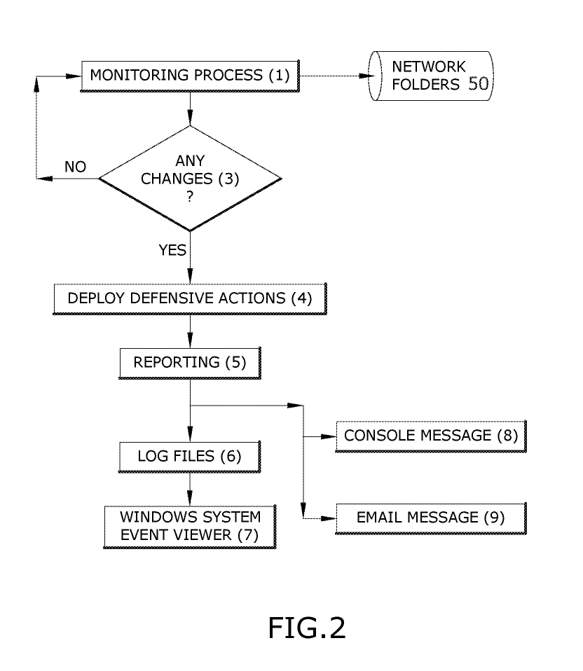

Referring to FIGS. 1 and 2, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

Referring to FIG. 1, the novel software application may be loaded onto a server, therein the novel software allows the administrator to create random honeypot files that are removably stored in folders 50 that the administrator wishes to protect. The honeypot files have identifiable characteristics, such as size, which may be randomized or randomly created by the present invention/administrator. The identifiable characteristics may include a name customized by the administrator to make each honeypot file different but also easily identifiable to users of the protected folders 50 so any accidental changes to these files by the users can be avoided. The novel software constantly monitors these honeypot files for any changes in identifiable characteristics, such as file size (file modifications), presence (deletion), location (moved) or rename operations. If the novel software detects any changes in identifiable characteristics or other unwanted action on the monitored honeypot files, a net file system modality 60 deploys defensive actions 70 to protect the server and coupled computing devices, as well as notify the administrator. The novel software enables the administrator takes appropriate actions to remove the ransomware and reverses the defenses allowing users to access the folders again.

Once an attack is detected, the software employs two or more defensive actions 70 to protect the server against further malicious action. First it may disable the network operating system, e.g., LANMANSERVER service, using various methods. Stopping this service immediately makes the shared folder unavailable to networked clients and the ransomware. Second, the software may add and enable a firewall rule that blocks SMB traffic to the protected server. Third, it may execute an optional, customizable script allowing defensive actions specific to the network being protected. Finally, the present invention may display a console message to all sessions, and notifying the administrator of the actions taken. The novel software enables the administrator to choose which folders 50 to protect on the server.

The installation and deployment of the novel software is part of what makes the present invention unique. An Application Configuration and Customization interface 10 enables a user not proficient in coding to quickly deploy honeypot files in the specific network folders 50 requiring protection, via either the GUI 20 and or the text file with parameters 30. This provides a significant benefit event if the optional customized script is not used.

Referring to FIG. 2, a method of using the present invention includes the following. In step 1, the network administrator may use the Application Configuration and Customization interface 10 to quickly define what folders 50 he or she desires to protect on the network. Also, the administrator can customize the embedded name in the file names of the honeypot files so that users of the network can easily identify the files and avoid triggering the defenses by accidentally changing, moving, resizing or deleting said files. The administrator can also change the characteristics of and the number of honeypot files installed in each shared network folder 50 needing protection in order to fool the ransomware into thinking that the files are legitimate. In step 2, the GUI interface 20 makes it easier to make the customized changes to the text file with parameters 30 or this file can be directly accessed by the network administrator if the GUI is not needed. The GUI interface 20 may also control the starting and stopping of the monitoring by the .net file system 60. When stopped, all honeypot files are removed from the network folders 50. In step 3, the text file with parameters 30 may direct the .net application 40 to make the customizations and define which folders 50 will be protected. In step 4, the .net application 40 installs honeypot files as directed in the shared network folders 50 needing protection. In step 5, the network folders 50 requiring protection are modified as directed by the insertion of honeypot files and monitoring begins by the .net file system 60. In step 6, the .net file system 60 starts or stops the monitoring of the honeypot files as directed by the .net application 40. The honeypot files are monitored for changes in file size, name, location, presence, and other identifiable characteristics. In step 7, the application triggered actions 70, which are customizable during setup, are triggers and always include the stopping of file sharing on the server and a firewall rule to stop SMB traffic among other things.

Referring FIG. 2, the combination of the ease and automation of deploying, removing and monitoring of honeypot files, the defensive actions taken to stop the spread of unwanted actions throughout a network, combined with the reporting on the status of the network at the time of the triggering event, make the operation of this invention unique. In step 1, the monitoring software senses any changes to the honeypot files. Monitoring of the honeypot files can be turned on and off. When turned on, the application places the honeypot files in the folders 50 specified during setup and monitors the size, location, name, presence of the files and other identifiable characteristics. When turned off, the application removes the honeypot files from the specified folders 50. This is very important since the files are visible to users accessing the shared folders 50 and there are times when the administrator may not want the files present to avoid questions or concerns such as when 3^{rd} party maintenance on the network is being conducted. In step 2, the honeypot files are placed in the network folders 50 that require protection as defined by the administrator during setup. The sizes of these files are randomized and the names are customized to make them different but also easily identifiable to users of the protected folders so any accidental changes to these files by the users can be avoided. In step 3, if no changes to the honeypot files are detected, then monitoring continues. If changes to the identifiable characteristics are detected, including renaming, resizing, moving or deleting, the application triggers defenses 70 in step 4 and reporting in step 5. In step 4, when changes are detected to the monitored files, the following defenses are deployed: (a) the application may stop the network operating system using forceful methods; (b) the application deploys a firewall rule to block inbound SMB traffic and traffic on any administrator defined ports; and (c) a custom script can be triggered as well to take other actions based upon the needs of the specific network being protected. In step 5, when changes are detected to the honeypot files, the reporting may include the following: (a) the application reporting software obtains a list of current SMB sessions and all open files and writes this information to a text file; (b) the application reporting software writes to the application log and records the event and also writes the same information to the windows event log for display in the Windows System Event Viewer; (c) the application emails the administrator (as defined during setup) a notice of the application being triggered. The email includes text attachments showing all open sessions and open files on the server at the time of the triggering event. The text of the message can be customized during setup; and (d) a customizable server console message is displayed to all windows including the session host display. In step 6, the event may be recorded in the application log and in the Windows event log, which can be viewed using the Windows System Event Viewer. In step 7, the Windows System Event Viewer is used to show the Windows System Event Log. In step 8, the Server Console displays a message sent by the application when the monitoring software detects a triggering event. The step 9, emails may be sent notifying the administrator that a triggering event has occurred and it includes text attachments showing all open sessions and open files on the server at the time of the triggering event. The text attachments serve to aid the administrator in finding the client machine that launched the malware. Once the rogue client is identified and removed from the network, the Administrator can reverse the defensive actions in step 4, and restore normal network file sharing and SMB traffic.

Additionally, since the software detects changes to special files installed randomly in folders needing monitoring, other threats to data besides encrypting ransomware, could also be detected and potentially stopped.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for identifying a presence of malicious software within a computer network, comprising:
storing a nonfunctional file having at least one original characteristic in a computer readable storage device that requires protection, wherein the nonfunctional file has no use outside of identifying the presence of malicious software; and
monitoring the nonfunctional file for determining a change in any original characteristic.

2. The method of claim 1, the nonfunctional file is stored in the computer readable storage device by way of a graphical user interface or a text file with parameters.

3. The method of claim 1, wherein each original characteristic is transmitted to a server application that provides the monitoring.

4. The method of claim 3, further comprising blocking commands within the computer network if a change in any original characteristic is determined, wherein a speed of the blocking commands is such that malicious software is blocked before damage to functional files can occur.

5. The method of claim 4, further comprising reporting all active sessions and open files within the computer network upon said determination, whereby a user may locate, isolate, and remove the malicious software from the computer network.

6. The method of claim 1, further comprising naming the nonfunctional file a predetermined name whereby users of the computer network know to not use said nonfunctional file.

7. The method of claim 1, wherein the at least one original characteristic includes one or more of the following: a file size, location, presence and type.

8. A method for identifying a presence of malicious software within a computer network, comprising:
storing by way of a graphical user interface or a text file with parameters a nonfunctional file having at least one original characteristic in a computer readable storage device that requires protection, wherein the nonfunctional file has no use outside of identifying the presence of malicious software, and wherein the at least one original characteristic includes one or more of the following: a file size, location, presence and type;
naming the nonfunctional file a predetermined name whereby users of the computer network know to not use said nonfunctional file;
monitoring the nonfunctional file for determining a change in any original characteristic, wherein each original characteristic is transmitted to a server application that provides the monitoring;
blocking commands within the computer network if a change in any original characteristic is determined, wherein a speed of the blocking commands is such that malicious software is blocked before damage to functional files can occur; and
reporting all active sessions and open files within the computer network upon said determination, whereby a user may locate, isolate, and remove the malicious software from the computer network.
